(19) United States
(12) Patent Application Publication
(10) Pub. No.: US 2007/0076543 A1
(43) Pub. Date: Apr. 5, 2007

(54) Information recording apparatus, information reproducing apparatus, information recording method, and information reproducing method

(76) Inventor: Yoshinori Tazaki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/525,832

(22) Filed: Sep. 25, 2006

(30) Foreign Application Priority Data
Sep. 30, 2005 (JP) 2005-288693

(51) Int. Cl. G11B 7/00

(52) U.S. Cl. 369/44.25; 369/44.13; 369/44.35

(57) ABSTRACT

An optical disc apparatus comprises a focus error detector which detects a focus error, a focus adjusting unit which adjusts a focus of a light beam at either of recordable layers based on an output from the focus error detector, a wobble signal detector which detects a wobbled groove and outputs a wobble signal, and a controller which holds an output of the focus error detector when a level of the wobble signal detected by the wobble signal detector is lower than a threshold level.

### CROSS-REFERENCE TO RELATED APPLICATIONS

This application is based upon and claims the benefit of priority from prior Japanese Patent Application No. 2005-288693, filed Sep. 30, 2005, the entire contents of which are incorporated herein by reference.

### BACKGROUND OF THE INVENTION

1. Field of the Invention

The present invention relates to an information recording apparatus, an information reproducing apparatus, an information recording method, and an information reproducing method which can use a recordable optical disc having a multilayer recordable layer.

2. Description of the Related Art

Recently, in order to increase a recording capacity, there has been developed a single-sided multilayer information storage medium such as an optical disc having two or three recording layers on its one surface. Information is recorded or reproduced while converging a laser beam onto the respective layers by moving an objective lens in its optical axis. direction. Further, there has been developed a double-sided multilayer information medium in which two of the above-mentioned recording mediums are pasted together. In these recording mediums, information is recorded or reproduced while layer-jumping is performed in which the focus point of the laser beam is shifted from one layer to another layer.

In the layer-jump, a laser beam must move widely, therefore, the focus servo may be out of control. In order to avoid this, U.S. Pat. No. 6,178,145 B1 which corresponds to Jpn. Pat. Appln. KOKAI Publication No. 11-219530 provides a disc reproducing system and a focus servo control system of a DVD system capable of forcedly holding a focus error signal and forcedly returning a beam spot to the target layer even in the case of failure of the layer jump in order to enhance the reliability when the beam spot is layer-jumped between plural layers. A focus control system according to the prior art comprises a focus error detector for detecting a positional difference between the focus position of the light beam and the selected one of the plural layered recording surfaces; a sample-hold circuit for sampling and holding an output of the focus error detector; a focus position correcting circuit for correcting the focus position of the light beam based on one of the output of the focus error detector and an output of the sample-hold circuit; a data signal level detector for detecting a signal level relating to data read out from the disc; a first comparator for comparing the signal detected by the data signal level detector with a predetermined level to output a result of comparison; and a selector for selecting one of the output of the focus error detector and the output of the sample-hold circuit as an input signal of the focus position correcting circuit based on the output of the first comparator.

However, the prior art relates to a focus servo control system using a read-only disc since it uses a data signal level detector for detecting a signal level relating to data read out from the disc. The focus servo control system according to the prior art cannot be used for a recordable optical disc.

In the recordable optical disc, if the layer-jump is carried out for a non-recorded area which does not output a data signal, there is a chance of failing in layer-jump. When reading out the data, error correction enables the data to be read out even if the layer-jump is failed. However, the data recording is not performed in success if the layer-jump is failed.

Further, when failing in layer-jump, there is rare chance that the other layer is subjected to the servo control, which provides a break down, or requires a long recovery time, as is distinct from the track-jump.

Moreover, when failing in layer-jump, the servo control is out of order; therefore, the disc itself could have been damaged.

### BRIEF SUMMARY OF THE INVENTION

An object of the invention is to provide an information recording apparatus, an information reproducing apparatus, an information recording method, and an information reproducing method, which are capable of carrying out layer-jump stably to a recordable multilayer information recording medium.

According to an embodiment of the present invention, an optical disc apparatus which is able to use an optical disc having recordable layers with a wobbled groove, the apparatus comprises:

a light source which emits a light beam to the optical disc;

a focus error signal generator which generates a focus error signal based on a reflected light beam from the optical disc;

a focus adjusting unit which adjusts a focus of the light beam emitted from the light source at either of the recordable layers based on an output from the focus error signal generator;

a wobble signal generator which generates a wobble signal based on the reflected light beam from the optical disc; and

a control unit which controls holding of an output of the focus error signal generator which is supplied to the focus adjusting unit when a level of the wobble signal generated by the wobble signal generator is lower than a threshold level.

According to another embodiment of the present invention, a focus adjusting method for an optical disc apparatus which is able to use an optical disc having recordable layers with a wobbled groove, the method comprises:

emitting a light beam to the optical disc;

generating a focus error signal based on a reflected light beam from the optical disc;

adjusting a focus of the emitted light beam at either of the recordable layers based on the focus error signal;

generating a wobble signal based on the reflected light beam from the optical disc; and

controlling holding of the focus error signal which is supplied to the focus adjusting when a level of the generated wobble signal is lower than a threshold level.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a schematic view showing a notebook type personal computer including an optical disc device according to an embodiment of the invention;

FIG. 2 is a schematic view showing an optical disc device according to the embodiment of the invention;

FIG. 3 is a schematic view showing a state in which a drawer section is extracted from the optical disc device of FIG. 2;

FIGS. 4A and 4B are block diagrams showing a circuit construction of the optical disc device according to the embodiment of the invention;

FIG. 5 is a sectional view of a recordable single-sided dual layer disc; and

FIG. 6 is a waveform chart showing a control method of the optical disc device according to the embodiment of the invention.

### DETAILED DESCRIPTION OF THE INVENTION

An embodiment of an information recording apparatus and an information reproducing apparatus according to the present invention will now be described with reference to the accompanying drawings.

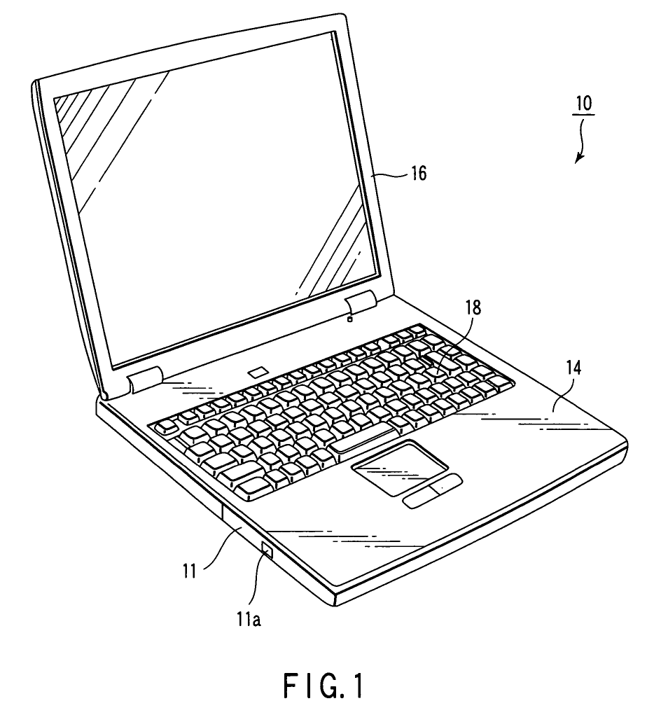

FIG. 1 shows a notebook type personal computer 10. The computer 10 includes a main body 14 and a display unit 16. The display unit 16 includes a display device such as a liquid crystal display (LCD) incorporated therein, and the LCD includes a display screen which is positioned substantially at a center of the display unit 16. The display unit 16 is attached to the main body 14 swingably between the open state and the closed state. FIG. 1 shows a front perspective view of an example of the personal computer 10 with the display unit 16 opened.

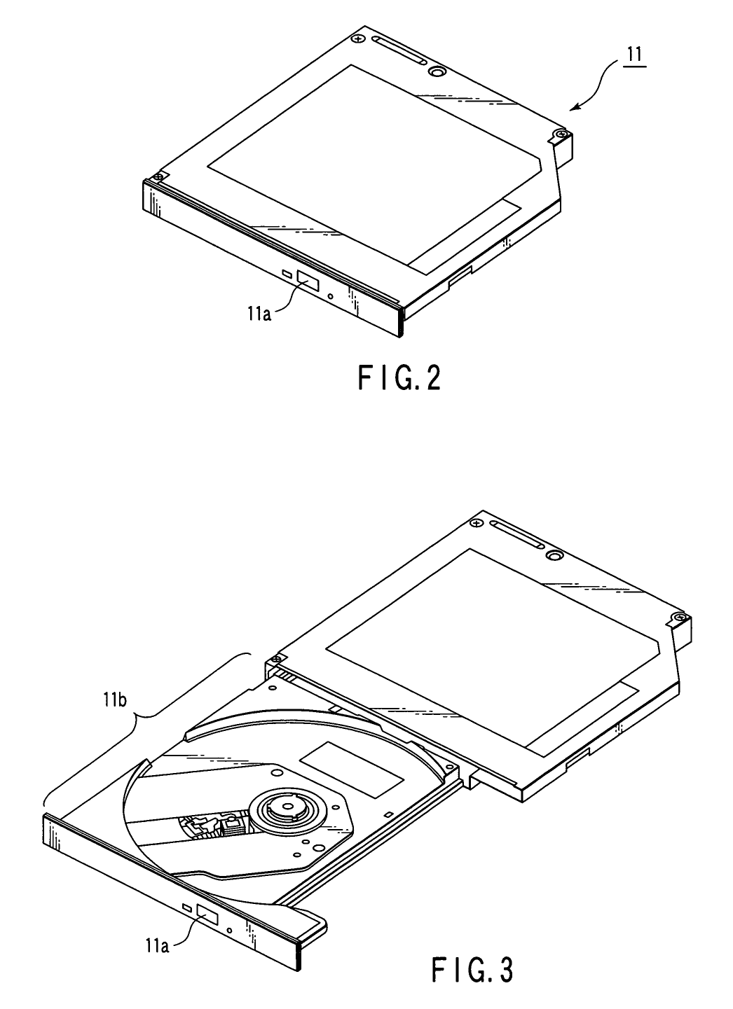

The main body 14 includes a substantial box-like case on which a keyboard 18 is disposed. Further, on a left side of the main body 14 is mounted a slim type optical disc device 11 having a built-in DVD drive and the like. The optical disc device 11 is shown in FIG. 2. The optical disc device 11 includes an eject button 11a. Pressing the eject button 11a causes a drawer section 11b to be extracted, as shown in FIG. 3.

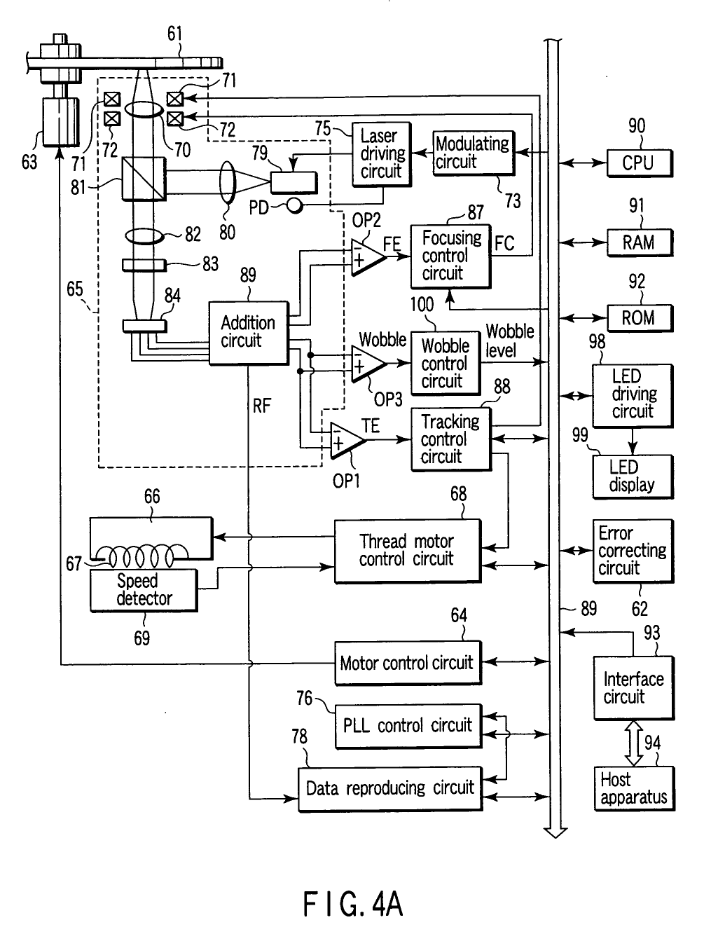

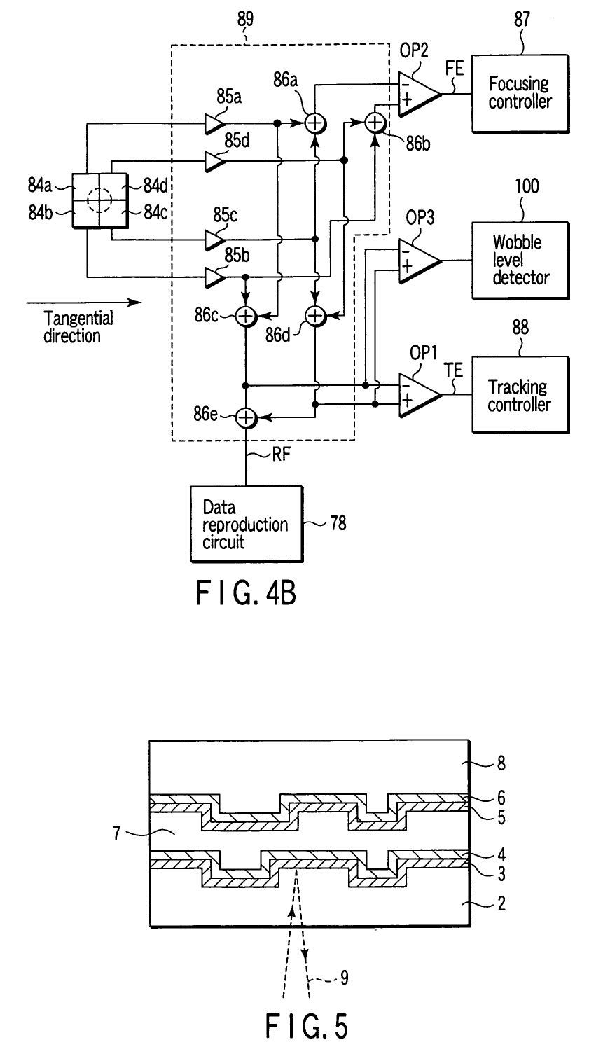

The computer 10 includes a semiconductor memory or a hard disc device for storing information to be recorded on the optical disc and information reproduced from the optical disc, and a CPU for instructing information-recording and information-reproduction to and from the optical disc device 11, and processing this information. Its circuit diagram is shown in FIGS. 4A and 4B.

FIGS. 4A and 4B are block diagrams showing electronic circuit diagrams of the optical disc device according to the embodiment of the invention. An optical disc 61 which is loaded in the optical disc device 11 can be of a user data recordable type multilayer optical disc or a read-only type multilayer optical disc. In this embodiment, a description will be given of the recordable type dual layer optical disc. The optical disc 61 having a dual layer includes a DVD-R, DVD-RW, DVD-RAM, or the like, but is not limited thereto and any other means may be employed insofar as it is recordable type dual layer optical disc.

The optical disc 61 includes a land truck and a groove truck formed in a spiral manner on its information recording surfaces. This optical disc 61 is rotatably driven by a spindle motor 63.

The optical disc 61 is information-recorded or information-reproduced by an optical pickup 65 (surrounded by broken line on a left side of FIG. 4A). The optical pickup 65 is connected to a thread motor 66 through a gear. The thread motor 66 is controlled by a thread motor controller 68.

A speed detector 69 is located below the thread motor 66, for detecting a moving speed of the optical pickup 65, and then is connected to the thread motor controller 68. A speed signal of the optical pickup 65 which is detected by the speed detector 69 is supplied to the thread motor controller 68. A permanent magnet (not shown) is disposed on a fixing section of the thread motor 66. When the thread motor controller 68 excites a driving coil 67, the optical pickup 65 is driven in a radial direction of the optical disc 61.

On the optical pickup 65 is an objective lens 70 supported by a wire or a plate spring (not shown), for example. The objective lens 70 is movable in a focusing direction (a lens optical axis direction) and a tracking direction (a direction perpendicular to the lens optical axis direction) by a drive of driving actuators 71, 72. A movement in the focusing direction (the optical axis direction) provides layer-jump. A modulator 73 receives a recording information signal from a host controller 94 through an interface circuit 93 and a bus 89 when recording information to the optical disc 61, and then modulates the recording information signal by a predetermined modulation manner (for example, 8-16 modulation) defined by a standard of the optical disc 61. A laser driver 75 supplies a write pulse to a semiconductor laser diode 79 based on a modulated data supplied from the modulator 73, when recording information to the optical disc 61 (when forming a mark). The laser driver 75 supplies a reading signal, which is smaller than the write pulse, to the semiconductor laser diode 79 when reproducing the information.

The semiconductor laser diode 79 generates a laser beam in response to a signal supplied from the laser driver 75. The laser beam emitted from the laser diode 79 is irradiated on the optical disc 61 through a collimator lens 80, a half prism 81, and the objective lens 70. The reflected light from the optical disc 61 is led to an optical detector 84 through the objective lens 70, the half prism 81, a focusing lens 82, and a cylindrical lens 83.

As shown in FIG. 4B, the optical detector 84 is constructed by quadrant optical detecting cells 84a to 84d. A pair of cells 84a and 84d is arranged in the tangential direction. A pair of cells 84b and 84c is arranged in the tangential direction. Output signals of the respective optical detecting cells 84a to 84d of the optical detector 84 are supplied to an addition circuit 89. In the addition circuit 89, four output signals of the optical detecting cells 84a to 84d are supplied to adders through current/voltage converting amplifiers 85a to 85d.

An adder 86a adds the output signals of the optical detecting cells 84a and 84c. An adder 86b adds the output signals of the optical detecting cells 84b and 84d. An adder 86c adds the output signals of the optical detecting cells 84b and 84a. An adder 86d adds the output signals of the optical detecting cells 84c and 84d. Adder 86e adds output signals of the adders 86c and 86d. Outputs of the adders 86a and 86b are supplied to inverting and non-inverting input terminals of an operational amplifier OP2. Outputs of the adders 86c and 86d are supplied to inverting and non-inverting input terminals of an operational amplifier OP1. Outputs of the adders 86c and 86d are supplied to inverting and non-inverting input terminals of an operational amplifier OP3.

The operational amplifier OP2 generates a focus error signal FE which is based on a detecting current ((Ib+Id)−(Ia+Ic)). Ia, Ib, Ic, and Id represent a detection currents of the cells 86a, 86b, 86c, and 86d. The focus error signal FE is supplied to a focusing controller 87. An output signal of the focusing controller 87 is supplied to the focusing driving actuator 72. Based on the output signal from the focusing controller 87, the laser beam is controlled so as to be just-focused on one of recording surfaces of the optical disc 61.

The operational amplifier OP1 generates a tracking error signal TE which is based on a detecting current ((Ic+Id)−(Ia+Ib)). The tracking error signal TE is supplied to a tracking controller 88, and then the tracking controller 88 generates a tracking driving signal in response to the tracking error signal TE. The tracking driving signal output from the tracking controller 88 is supplied to the tracking driving actuator 71 for driving the objective lens 70 in a direction perpendicular to its optical axis. The laser beam is controlled so as to be irradiated on a predetermined track on the recording surface of the optical disc 61 based on the tracking driving signal. The tracking error signal TE which is used in the tracking controller 88 is also supplied to the thread motor controller 68.

The output signal of the operational amplifier OP3 is supplied to a wobble level circuit 100. The wobble level circuit 100 generates a wobble level signal.

As described above, carrying out the focusing control and the tracking control leads to a sum signal of the output signals of the optical detecting cells 84a to 84d of the optical detector 84, that is, an output signal RF of the adder 86e for adding the output signals of the adders 86c, 86d, thereby providing a signal which corresponds to the recording information. This output signal RF is supplied to a data reproduction circuit 78.

The data reproduction circuit 78 reproduces the read recording data based on a reproducing clock signal from a PLL controller 76. The data reproduction circuit 78 includes a measuring function for measuring an amplitude of the RF signal. The measured value is output to a CPU 90 through the bus 89.

The thread motor controller 68 controls the thread motor 66, and hence moves the optical pickup 65 in such a manner that the objective lens 70 is positioned in the vicinity of a center of the optical pickup 65.

The motor controller 64, the thread motor controller 68, the modulator 73, the laser driver 75, the PLL controller 76, the data reproduction circuit 78, the focusing controller 87, the tracking controller 88, or the like can be formed in one LSI chip, and then be controlled by the CPU 90 through the bus 89. The CPU 90 comprehensively controls the optical disc device according to an operational command supplied from the host controller 94 through the interface circuit 93. The CPU 90 uses a RAM 91 as a work area, and then carrying out a predetermined control according to a program stored in a ROM 92, including a process according to the embodiment of the present invention.

FIG. 5 shows a cross-sectional view of a single-sided dual layer recordable disc (write-once disc). The single-sided dual layer disc has the first transparent substrate 2 made of polycarbonate at the side of an incident plane (read surface) of a laser beam 9 emitted from the objective lens 70. The first transparent substrate 2 has translucency for a wavelength of a laser beam.

A first recording layer (Layer 0) 3 is provided on a plane opposite to the light incident plane of the first transparent substrate 2. Recording marks corresponding to recording information are formed on the first recording layer 3. An optical semi-transparent layer 4 is provided on the first recording layer 3.

A space layer 7 is provided on the optical semi-transparent layer 4. The space layer 7 serves as a transparent substrate with respect to Layer 1, and has translucency for a wavelength of a laser beam.

A second recording layer (Layer 1) 5 is provided on a plane opposite to the optical incident plane of the space layer 7. Recording marks corresponding to recording information are formed on the second recording layer 5. An optical reflection layer 6 is provided on the second recording layer 5. A substrate 8 is formed on the optical reflection layer 6. Though not shown in FIG. 5, a groove is wobbled in a predetermined period.

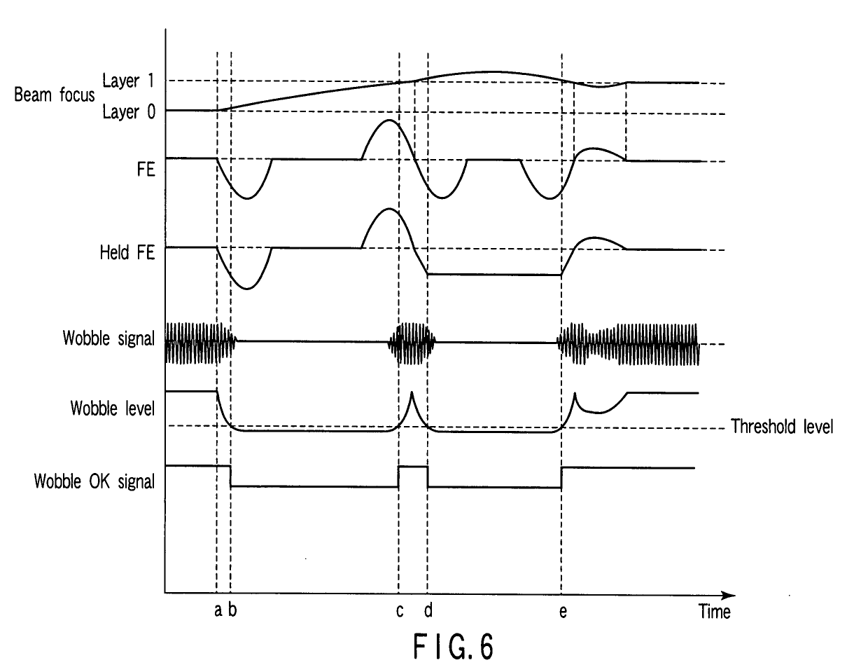

Next, referring to FIG. 6, an operation of the optical disc device according to the embodiment will be described. When the optical disc 61 is loaded into the optical disc device, the optical disc device checks the type of the optical disc 61. If the optical disc device determines that the type of the optical disc 61 is a recordable disc, the layer-jump is performed as shown in FIG. 6. If the optical disc device determines that the type of the disc is a read-only disc, the layer-jump is performed based on the signal level relating to data read out from the disc as described in the background.

For a recordable disc, the optical disc device carries out hysteresis control using the level of a wobble signal, to thereby control a focus servo control in a stable manner. The RAM 91 stores a threshold level of the wobble signal. The CPU 90 monitors the wobble level and the threshold level stored in the RAM 91.

At time a, the CPU 90 starts a layer-jump process from Layer 0 to Layer 1. To perform layer-jump, the CPU 90 supplies a jump signal to the focusing driving actuator 72. Normally, a beam focus is converged to the target layer by a focus servo control. However, if the surface deviation of a disc is large, the beam focus cannot be converged to the target layer even by a focus servo control.

As the beam focus moves, the focus error signal FE is generated from the operational amplifier OP2 and the level of the wobble signal output from the wobble level circuit 100 is decreased.

At time b, the wobble signal is not generated any more and the wobble level becomes lower than the threshold level. Thus, the CPU 90 sets a wobble OK signal to a low level indicating that the wobble signal is not generated.

When the beam focus is close to Layer 1, the focus error signal FE is generated to turn on the focus servo control. At time c, the wobble signal is generated again and the wobble level becomes higher than the threshold level. The CPU 90 sets the wobble OK signal to a high level indicating that the wobble signal is generated.

The beam focus reaches Layer 1 between time c and time d. After reaching Layer 1, the beam focus overruns beyond Layer 1 due to an overshoot, the polarity of the focus error signal FE is changed and the wobble level is decreased.

At time d, the wobble level becomes lower than the threshold level and the CPU 90 determines that the beam focus goes away from Layer 1 and changes the level of the wobble OK signal to the low level. Based on the second level change of the wobble OK signal from high to low (at a time d), the CPU 90 controls the focusing controller 87 and hold of the focus error signal FE of the point in time d. Then, the focusing controller 87 holds the focus error signal FE and outputs the held focus error signal FE to the focusing driving actuator 72. The focusing driving actuator 72 controls the laser beam based on the held focus error signal FE so as to be just-focused on Layer 1. Stated another way, a hysteresis control is performed to return the beam focus to Layer 1.

If the focus error signal FE is not held at time d, the focus error signal FE is decreased while the beam focus goes away from Layer 1 so that the focus servo may be failed.

Due to the hysteresis control, the beam focus is returned to close to Layer 1. At time e, the wobble level exceeds the threshold level again and the level of the wobble OK signal is changed to the high level. The focusing controller 87 stops holding the focus error signal FE and outputs the real-time focus error signal FE to the focusing driving actuator 72. The focusing driving actuator 72 controls the laser beam based on the focus error signal FE so as to be just-focused on Layer 1.

By repeating the above-mentioned operations, the beam focus is controlled so as to come close to the target layer of the multilayer optical disc.

As described above, when the beam focus exceeds the target layer and hence the wobble level is less than the threshold level, the focusing controller 87 holds the focus error signal FE, and then controls and actuates the focus servo based on the held focus error signal FE. That is, in the case of layer-jumping from one layer (Layer N) to an adjacent layer (Layer (N+1)), when the beam focus exceeds the target Layer (N+1), the focusing driving actuator 72 is controlled by a control signal for returning the beam focus to Layer (N+1). Then, when the beam focus comes close to Layer (N+1) again, the CPU 90 releases the focusing controller 87 from its holding of the focus error signal FE to thereby carry out the focus servo control in such a manner that the beam focus comes close to the target layer.

The same is true of a case in which the beam focus comes close to Layer N by actuating the objective lens 70 in a focus servo control direction. When the wobble level is less than the threshold level again, the focusing controller 87 holds the focus error signal FE, and then the focusing driving actuator 72 is controlled by a control signal for returning the beam focus to Layer (N+1).

According to the embodiment, there is provided an optical disc device and a method of controlling the optical disc device which detects the level of a wobble signal specific to a recordable disc, and stably and safely controls a layer-jump by using the detected wobble level. This also leads to protect a user's content which is recorded in the optical disc.

In the above embodiment, the wobble signal is used to detect the overrun of the beam focus. If the fluctuation of the radial deviation is not large, the wobble signal cannot be detected. In order to surely detect the wobble signal, the tracking controller 88 causes the tracking driving actuator 71 to shift (wobble) the laser beam at a predetermined frequency. For example, if the wobble signal is not detected at time a, the CPU 90 drives the tracking controller 88.

Moreover, a DPP (Differential Push-Pull) tracking signal may be used in place of the wobble signal.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An optical disc apparatus which is able to use an optical disc having recordable layers with a wobbled groove, the apparatus comprising:
a light source which emits a light beam to the optical disc;
a focus error signal generator which generates a focus error signal based on a reflected light beam from the optical disc;
a focus adjusting unit which adjusts a focus of the light beam emitted from the light source at either of the recordable layers based on an output from the focus error signal generator;
a wobble signal generator which generates a wobble signal based on the reflected light beam from the optical disc; and
a control unit which controls holding of an output of the focus error signal generator which is supplied to the focus adjusting unit when a level of the wobble signal generated by the wobble signal generator is lower than a threshold level.

2. An optical disc apparatus according to claim 1, further comprising a shift control unit which causes a tracking servo mechanism to shift the focus of the light beam in a tracking direction when the wobble signal generator does not generate the wobble signal.

3. A focus adjusting method for an optical disc apparatus which is able to use an optical disc having recordable layers with a wobbled groove, the method comprising:
emitting a light beam to the optical disc;
generating a focus error signal based on a reflected light beam from the optical disc;
adjusting a focus of the emitted light beam at either of the recordable layers based on the focus error signal;
generating a wobble signal based on the reflected light beam from the optical disc; and
controlling holding of the focus error signal which is supplied to the focus adjusting when a level of the generated wobble signal is lower than a threshold level.

4. A method according to claim 3, further comprising causing a tracking servo mechanism to shift the focus of the light beam in a tracking direction when the wobble signal is not generated.
